(19) United States
(12) Patent Application Publication
(10) Pub. No.: US 2006/0101024 A1
(43) Pub. Date: May 11, 2006

(54) Reproducing apparatus, reproducing method and software thereof

(75) Inventor: Meeko Kuwahara, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/115,708

(22) Filed: Apr. 26, 2005

(30) Foreign Application Priority Data
Nov. 5, 2004 (JP) 2004-321450

(51) Int. Cl. G06F 17/30

(52) U.S. Cl. 707/10

(57) ABSTRACT

For the purpose of managing and/or protecting meta information of contents, which are accumulated within a recording accumulation medium and/or a recording/reproducing apparatus, there is provided meta data for managing the meta information, when managing the contents data, without managing/controlling by each of users when producing and compiling the contents data, thereby making conditions and/or regions relating to the meta information controllable.

### BACKGROUND OF THE INVENTION

1. Field of the Invention

The present invention relates to management/protection for meta information of contents data.

2. Description of Prior Art

The following Patent Document 1 is already known, which describes the background technology in relation to the present invention. In more details, “aiming to provide a service enabling protection of the rights of contents, and/or protection of the rights of individual of a users” (see, column 0005 of the Patent Document 1), there is description about “The contents are produced by a unit, which is intended by a broadcasting provider, and are attached with contents-related information, for each of them. As the meta data attached to each of the contents, it is assumed to include the following information; i.e., starting from general information relating to the contents, up to copyright protection information, right information relating to accumulation/reproducing, etc. With this, it is possible to obtain fine control for each of the contents. Also, it is possible to define a method for providing the contents to a viewer/listener and a method of using thereof, on the broadcaster side, accumulation of the contents under the coding condition thereof, limited receiving to a terminal, and limited receiving to an individual, etc, and the services are provided, which enable the protection of the rights of contents, such as, of the copyright, etc., through conducting the view/listen control of the viewer/listener, an accumulation control, a copy control, a coding/decoding control, etc., upon the basis those definitions” (see, column 0006).

Patent Document 1: Japanese Patent Laying-Open No. 2002-203070 (2002)

### SUMMARY OF THE INVENTION

Also, in the Patent Document 1, there is description, that the individual or personal information and/or contact information, as being the meta information, are encoded and distributed (see, for example, column 0033 and FIG. 9). However, inherently, such the individual or personal information and/or the contract information, which are encoded, are not for use in searching.

An object, according to the present invention, is to enable management/protection of the meta information, which can be used in the searching, inherently.

The object of the present invention can be dissolved by the invention, which is described in the pending claims attached herewith.

Thus, according to the present invention, it is possible to provide a reproducing apparatus, a recording/reproducing apparatus, a reproducing method, a recording/reproducing method, and a software thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the structure of a first embodiment 1 according to the present invention;

FIGS. 2(A) to 2(C) are structural views for showing contents data in the embodiment 1;

FIGS. 3(A) and 3(B) are structural views for showing meta data in the embodiment 1;

FIG. 4 is a block diagram for showing the structure of a monitoring system in an embodiment 2;

FIG. 5 is a block diagram for showing the structure of a contents distribution service in an embodiment 3;

FIG. 6 is a flowchart of meta information management in the embodiment 1; and

FIG. 7 is a structural view of FIG. 2 in an embodiment 4.

### DESCRIPTION OF THE PREFERRED EMBODIMENTS

Hereinafter, embodiments according to the present invention will be fully explained by referring to the attached drawings.

In a case where meta information is produced for protecting/managing an individual or personal data, the right information, etc., which are stored in the contents data, separating from protection function of the contents data, and distribution is conducted upon the contents, it is possible to protect the meta information having high secrecy and/or authority from leaking, even if edition, copy, download or the like is conducted upon the contents. Herein, the meta information is additional information, which describes the meaning or contents of data to be targeted, and it is data, which is utilized in the searching, etc.

### EMBODIMENT 1

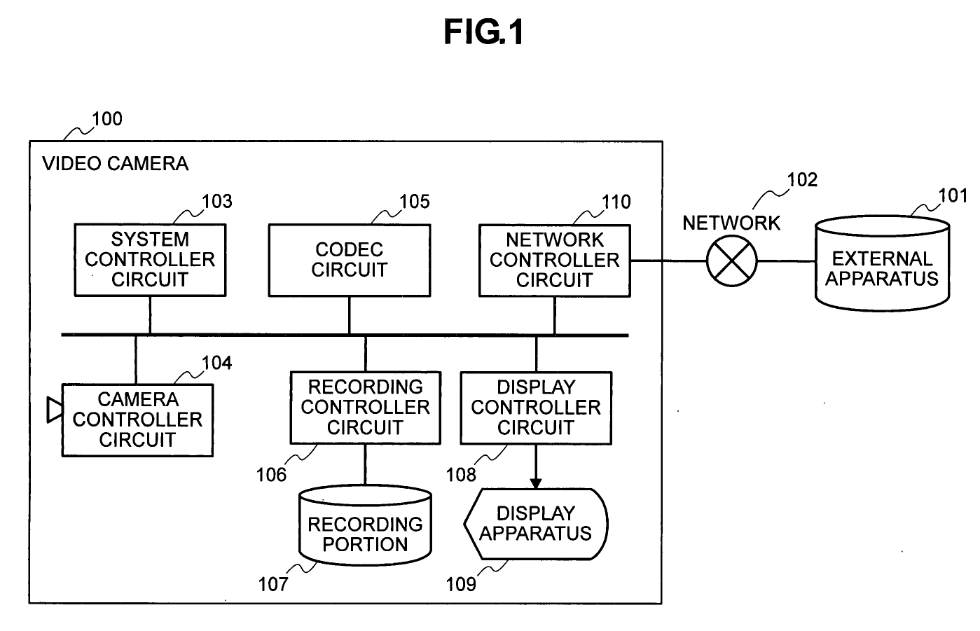

Hereinafter, explanation will be made about an embodiment according to the present invention. FIG. 1 is the structural view of a recording/reproducing apparatus according to an embodiment, and an external apparatus, which is connected with that recording/reproducing apparatus thought a network.

In FIG. 1, a reference numeral 100 depicts a video camera, 101 an external apparatus, being connectable with the video camera, and 102 the network. A system controller circuit 103 includes a CPU and/or a memory, so as to control a system as a whole. Though not shown in the figure, but in general, input information inputted when a user operates a button, etc., is also processed by the system controller circuit 103. A camera controller circuit attached with a reference numeral 104 obtains video data when recording, and it delivers data to a CODEC (COmpression/DECompression) circuit 105. The CODEC circuit of reference numeral 105 performs video compression, such as, the MPEG (Moving Picture Experts Group) and/or the JPEG (Joint Photographic coding Experts Group), for example. The contents data compressed within the CODEC circuit 105 is recorded into a recording portion 107 within a recording controller circuit 106. The recording portion 107 should not be limited to a hard disk or a removable recording medium, nor inner orouter, suchas, anopticaldisk, amemory, acard, but the similar effect can be obtained therefrom. The video data, which can be obtained within the camera controller circuit 104 when recording, and also contents data obtained through processing of decoding (extending) upon the data, which the recording controller circuit 106 reads out from the recording portion 107 when reproducing, within the CODEC circuit 105, are outputted to a display apparatus 109 by means of a display controller circuit 108. A network controller circuit 110 performs a process of transmitting the said video data to the network. With this, it is possible to transmit the video data to the external apparatus 101. Thus, they can be accessed from equipment, such as, a mobile phone, a PDA, or a PC, for example, which may be connected to the network. When recording the contents data into the recording portion 107, the meta information is stored into a header information portion of the contents data.

Herein, the meta information may include a date and a place, when and where the contents data are produced, and a name of a person who is involved into the contents data and a producer's name, etc. Those meta information can be used in the searching.

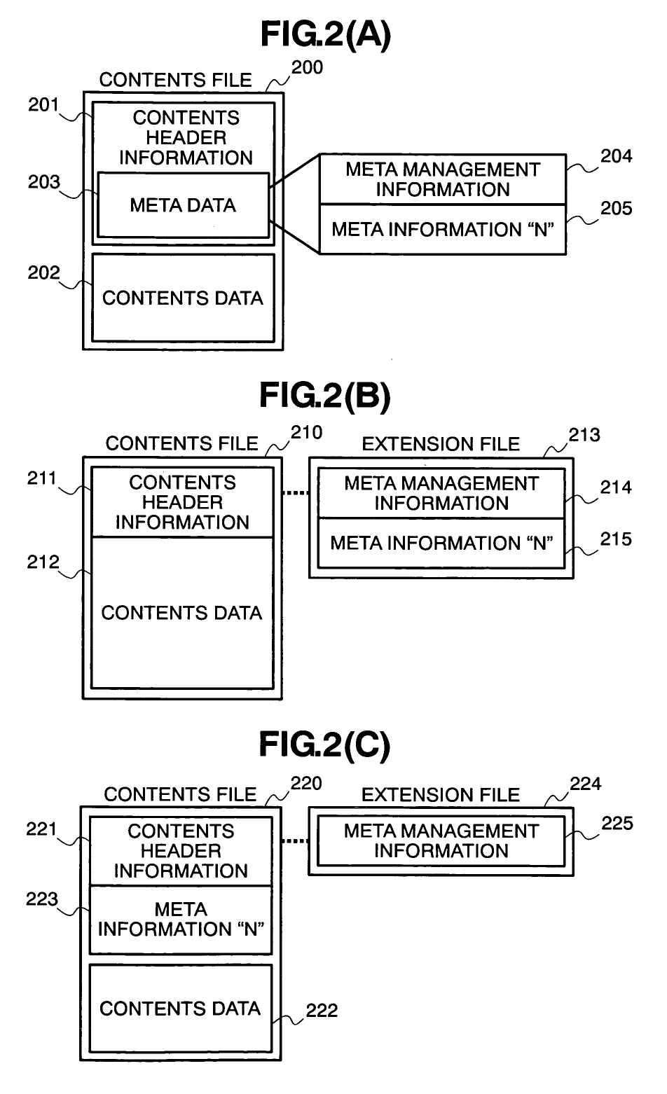

FIGS. 2(A) to 2(C) are views for showing the structure of the contents data, which will be used in the recording/reproducing apparatus according to the one embodiment, into which the present invention is applied. In FIG. 2(A), there is shown the configuration, where the meta information is stored into a contents header portion. A reference numeral 200 indicates a contents file. A reference numeral 201 indicates header information of the contents, into which the information are stored; i.e., information for confirming upon the said information file, of which kind information file it is, and for searching thereof, and other than that, the information of the recording date and/or size thereof. A reference numeral 202 indicates the contents data. A reference numeral 203 indicates the meta data, in which is stored a plural number of information relating to the contents. Into the port of reference numeral 204 is stored the data formanaging themeta data. Areference numeral 205 is the meta information relating to the contents. The details thereof will be mentioned later.

In FIG. 2(B), there is shown the file structure, in a case where the meta information into the contents are stored, as to be other extension file separate from that contents file. A reference numeral 210 indicates the contents file. A reference numeral 211 indicates the header information of the contents, into which the information are stored; i.e., information for confirming upon the said information file, of which kind information file it is, and for searching thereof, and other than that, the information of the recording date and/or size thereof. A reference numeral 212 indicates the contents data. A reference numeral 213 indicates the extension file, into which the meta information is stored. Into a part 214 are stored the information for managing the meta information, and/or the information relating to the authorization or the like of the user. A reference numeral 215 is the meta information relating to the contents associated therewith.

In FIG. 2(C), there is shown the file structure when storing the management information about the meta information of the contents file as an extension file other than that contents file. A reference numeral 220 indicates the contents file. A reference numeral 221 indicates the header information of the contents file, and a reference numeral 222 the contents data. A reference numeral 223 indicates the meta information relating to the contents, which is includedwithin the contents header portion. A reference numeral 224 indicates the extension file of the contents file. Into a part of reference numeral 225, there are stored the information for managing the meta information 223 of the contents file 220, and/or the information relating to the authorization of the user, etc.

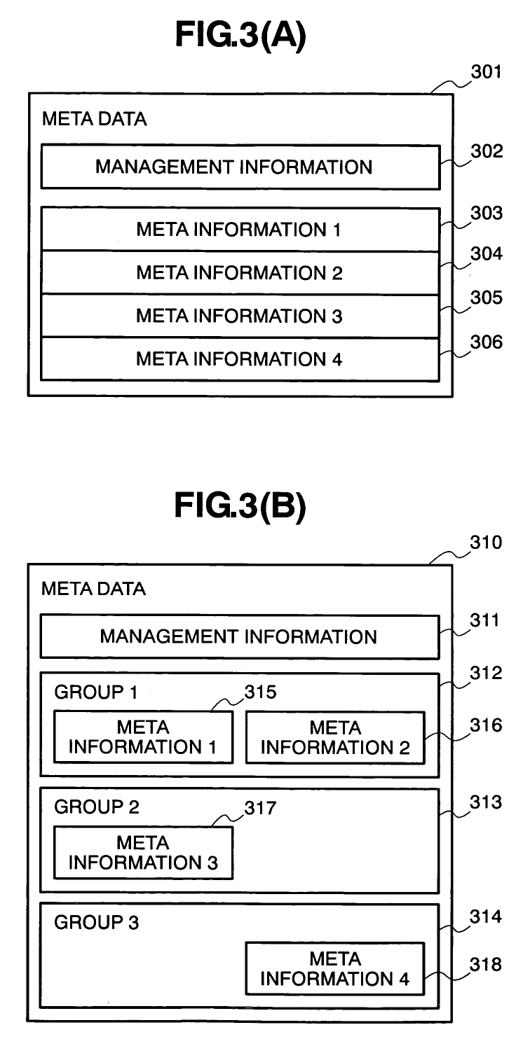

FIGS. 3(A) and 3(B) show an example of the structures of the meta data relating to the contents. In FIG. 3(A), a reference numeral 301 is a group of meta data relating to the contents. A reference numeral 302 indicates the information, which enables to manage and/or control the meta data. Reference numerals 303-306 are the meta information, each relating to the contents, respectively. In the management information 302 are included the management information, relating to each of the meta information 303-306, thereby controlling reading and searching of the meta information under the authorization of the user. A user “A” is able to read and re-write the meta information among the meta information 303-306, and a user “B” is able to read the meta information among the meta information 303-306. A user “C” is able to read the meta information 303 and 304, and if the meta information 303 is re-writable, filtering is conducted with the management information upon the meta information, so that each user can deal with the meta information, only as a restriction permits. As a method for managing the authorization of users, it is possible to manage the users by a unit of a group, and in such an instance, it is also possible to obtain the similar effects as was mentioned above.

A reference numeral 310 in FIG. 3(B) indicates the meta data group relating to the contents. A reference numeral 311 is the information, which enables to mange and to control the meta data. Reference numerals 312-314 are groups, into which the meta data are classified. Reference numerals 315-318 are meta information, relating to the contents, respectively. In a case where the authorization of reading and/or re-writing, etc., by the user is managed byaunit of group, and where the meta information is divided into groups, it is also possible to obtain the similar effects as in the case of FIG. 3(A).

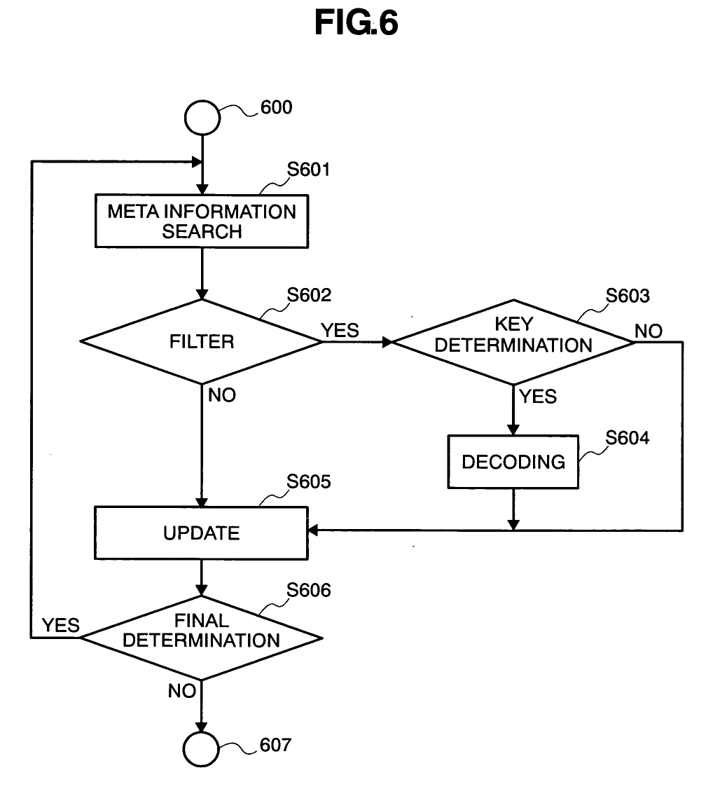

FIG. 6 is an example of the operation flows for management of the meta information, according to the present invention. A reference numeral 600 indicates the meta information of the original contents data. Within the reproducing apparatus, aprocess S601 is started of referring to the meta information, and then it is determined on whether the filtering is treated or not upon the meta information in a step S602. When determining that the filtering is treated thereupon, key determination is conducted in a step S603, and then if the apparatus or a user of that apparatus owns a key for descrypting the filtering, the meta information is decoded in a step S604, and is updated in a step S605. Or, if no key is owned in the step S603, then it is determined that there is no meta information to be targeted. If no filtering is treated in the step S602, the meta information is updated in the step S605, as it is. Then, a final determination is conducted in a step S606, and then if there is remained the target information, the process turns back to the searching of meta information of the step S601, while no target information remains, the meta information 607 within the reproducing apparatus is disclosed or opened.

With doing so, as was mentioned above, it is possible to protect the private information, such as, personal information in the form of meta information or the like, for example. Also, for a user, it is possible to discriminate the services of using the meta information therein.

### EMBODIMENT 2

Hereinaf ter, description will be made about the second embodiment according to the present invention. In the embodiment 1, there was described that the discrimination can be achieved on the services of using the meta information therein, for each of the users, by protecting the meta information that can be used in the searching, or by restricting the reading and using thereof. However, in the present embodiment, it is characterized that the restriction is made upon, not only the meta information, but also the reading and using of the contents data relating to that meta information.

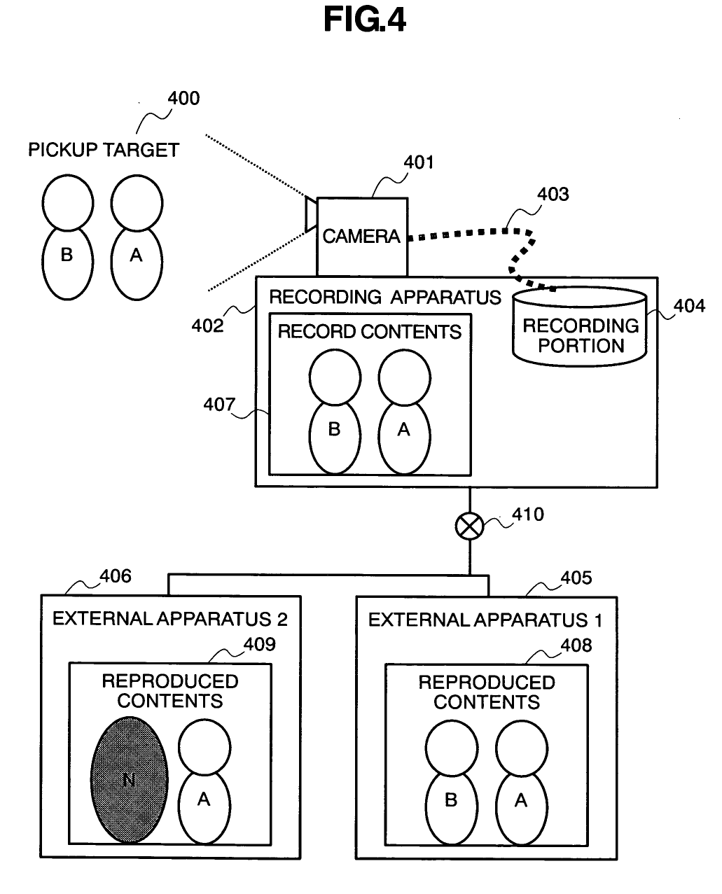

FIG. 4 shows an example of the structure of a monitoring apparatus. A reference numeral 400 indicates a target to be taken image thereof. A reference numeral 401 is a camera for monitoring, 402 a recording apparatus for recording and accumulating the contents data taken up through the camera 401, and 403 a line for connecting between the camera 401 and the recording apparatus 402, which may be wireless or a wired line. A reference numeral 404 is the recording portion of the recording apparatus, being provided for accumulating the contents recorded into the recording apparatus 402. Reference numerals 405 and 406 are external apparatus, each of which is connectable to the recording apparatus 403. Reference numerals 407-409 indicate contents, and in particular, the reference numeral 407 indicates the original data of those 408 and 409. A reference numeral 410 indicates a network for connecting the external apparatuses 405 and 406 and the recording apparatus 402. Hereinafter, explanation will be made on the examples, where the authorization is different from between the external apparatuses 405 and 406, respectively, in particular, in the case where the camera 401 picks up an image of the target 400 to be taken, so as to record the image data into the recording portion 404 of the recording apparatus 402, and in the case where the external apparatuses 405 and 406 are connected to the recording apparatus 402 through the network 410, so as to view/listen the recording contents 407, which is recorded in the recording portion 404. In a case where the external apparatus 405 has an authorization of being able to read the meta information, but unable to re-write, and when reproducing the recording contents 407, then the external apparatus 405 is able to see the recording data as is in the form of the original data thereof. In the case where the external apparatus 406 has an authorization of being able to read a part of the meta information, but unable to re-write, then the external apparatus 406 is able to reproduce the recording data, upon which the filtering process is made. Namely, the data 408 and 409 to be reproduced by the management meta data, which manages the meta information of the recording contents, comes to be different in the reproducing format thereof. Also, under the condition that there are a person called by “A” and a person called by “B”, as a target to be taken image thereof, and if the recording contents 407 has the meta information relating to each of the persons, “A” and “B”, but if the external apparatus 406 has no authorization of reproducing for the person called by “B”, it is also possible to control replacing the meta information that the person called by “B” is recorded with other information “N”, by means of the meta data having the managing information; such as, displaying the person called by “B” with treating a mask processing thereon, such as, a mosaic processing, for example. The structure of the meta data having the managing information may have the similar effects in any configuration shown in FIGS. 2(A) to 3(B).

In particular, the above-mentioned is effective, in particular, when applying into an observation or surveillance camera, since there are many cases of including the private information therein. For example, in a camera system for observing or monitoring an old man living alone, it is possible to achieve step-like controls; i.e., the family members of a first degree can see all of the video, the relatives of a second degree almost of all the video, and the relatives of a third degree only a part of the video, etc.

### EMBODIMENT 3

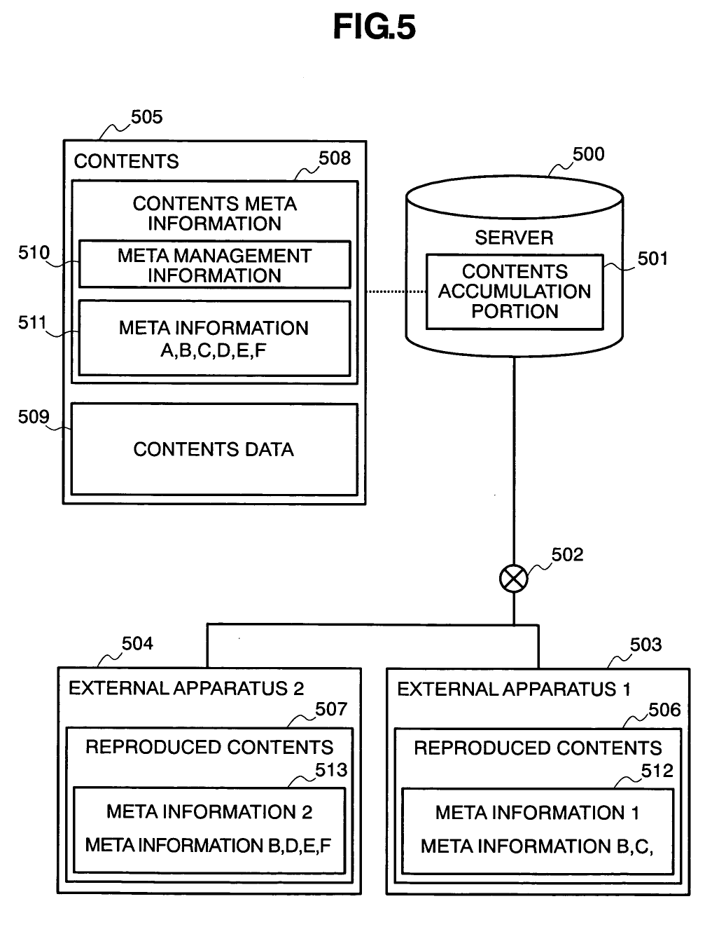

Hereinafter, explanation will be made about a third embodiment. FIG. 5 shows an example of the structure of a contents distribution service. A reference numeral 500 is a server for conducting a contents distribution service. A reference numeral 501 is a contents accumulation portion of the server 500, accumulating the contents data therein, on which the distribution service is conducted. A reference numeral 502 is a network for conducting the distribution service. Reference numerals 503 and 504 are external apparatuses, each of which receives the distribution service. A reference numeral 505 is the original contents to be used in the distribution service, and 506 and 507 are contents data when the contents 505 are reproduced in the external apparatuses 503 and 504. A reference numeral 508 is the contents meta information of the contents 505, and 509 the contents data.

A reference numeral 510 is the meta management information of the contents meta information, and 511 each meta information. A reference numeral 512 is the meta information, which can be referred by the reproduced contents that can be reproduced in the external apparatus 503, and 513 is the meta information, which can be referred by the reproduced contents that can be reproduced in the external apparatus 504. In the external apparatus 503, the authorization of being able to refer the meta information lies in the meta information B and C within the meta information 511, and the management thereof is conducted by the meta management information 510. Also in case of transmitting the contents 505 when distributing, for the meta information of the reproduced contents 506, it is only possible to refer to “B” and “C”, under the authorization of the apparatus 503. After receiving in the apparatus 503, also when the external apparatus 503 distributes the reproduced contents 506 to the external apparatus 504, since the management information 510 is included in the contents, and since referring authorization of the meta information are only to the meta information “B”, “D”, “E” and “F” within the external apparatus 504, it is possible to refer to the meta information of the said authorization. This means that the reproduced contents 507 can be obtained, which is same to that obtained in the case where the external apparatus 504 obtains the contents 505 via the server 500.

Also, when distributing to the external apparatus, it is also possible to newly produce the management information, again, in the meta management information, and in such the instance, the management information is produced which has other rule. In such the instance, since the management is for the contents 506 which is received at the external apparatus 503, if the distribution is made to the external apparatus 504 after the receiving in the structure as was mentioned above, it is possible to refer the meta information under the new meta information referring authority of the reproduced contents 506. The structure of the meta data having the managing information may have the similar effects in any configuration shown in FIGS. 2(A) to 3(B).

### EMBODIMENT 4

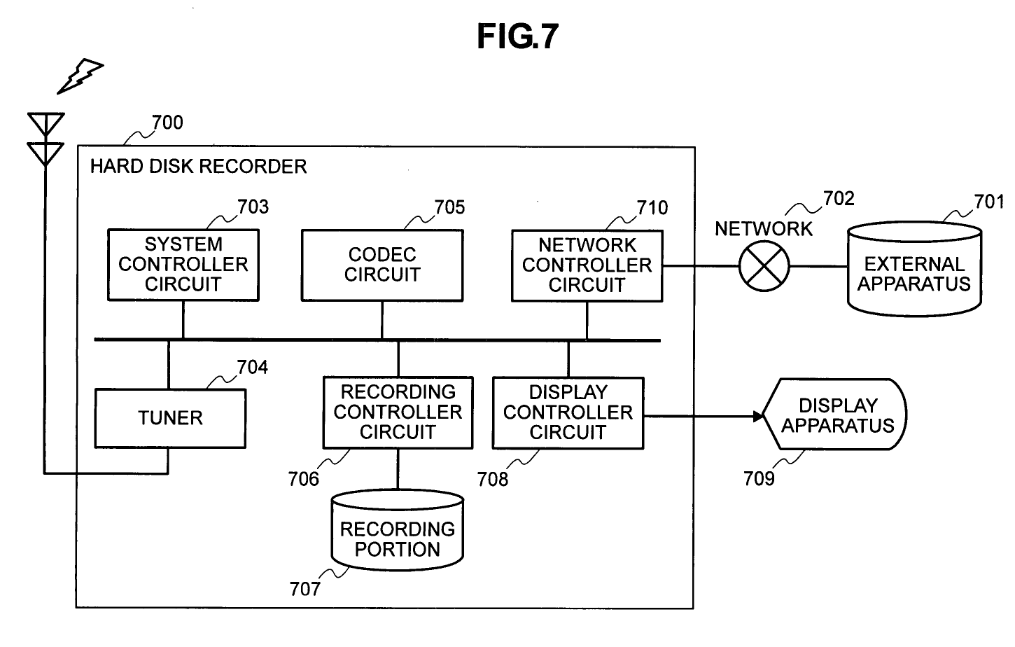

Hereinafter, explanation will be made about a fourth embodiment according to the present invention. FIG. 7 is the structural views of the recording/reproducing apparatus and a display apparatus, according to one embodiment, into which the present invention is applied, as well as the external apparatus, which is connected to that recording/reproducing apparatus through the network.

In FIG. 7, a reference numeral 700 depicts a hard disk recorder, 701 an external apparatus, which is connectable to the hard disk recorder, and 702 a network. A system controller circuit 703 includes a CPU and/or a memory, thereby controlling the system as a whole. Though not shown in the figure, but in general, input information inputted when a user operates a button, etc., is also processed by the system controller circuit 703. A tuner of 704 obtains the video data when receiving, and delivers the data to the CODEC (COmpression/DECompression) circuit 705. The CODEC circuit of reference numeral 705 performs video compression, such as, the MPEG (Moving Picture Experts Group) and/or the JPEG (Joint Photographic coding Experts Group), for example. The contents data compressedwithin the CODEC circuit 705 is recorded into a recording portion 707 within a recording controller circuit 706.

The recording portion 707 should not be limited to a re-writable hard disk or a removable recording medium, nor inner or outer, such as, an optical disk, amemory, a card, but the similar effect can be obtained therefrom. The video data, which can be obtained by the tuner 704, and/or the contents data, which is obtained from the data that the recording controller circuit 706 reads out from the recording portion 707 when reproducing, through the decoding (extension) process within the CODEC circuit 705, are outputted onto a display apparatus 705, within a display controller circuit 708. A network controller circuit 710 performs a process of transmitting the said video data to the network. With this, it is possible to transmit the video data to the external apparatus 701. Thus, they can be accessed from equipment, such as, amobile phone, aPDA, oraPC, forexample, whichmaybe connected to the network. When recording the contents data into the recording portion 707, the meta information is stored into a header information portion of the contents data. The structure of the meta data having the managing information may have the similar effects in any configuration shown in FIGS. 2(A) to 3(B).

### EMBODIMENT 5

Hereinafter, explanation will be made about a fifth embodiment. The structure of the meta data having the management information has the similar effects in the contents data, which are recorded/stored onto a recording medium, and also has the similar effects in any configuration shown in FIGS. 2(A) to 3(B). Further, it is needless to say that software is also one of the embodiments, for achieving controlling to obtain such the operations, as in those embodiments mentioned heretofore.

With the mentioned above, it is possible to obtain the discrimination upon using of the meta information for each of the users, depending on the producer of contents and/or a spouse, etc. Also, it is possible to make the private information and/or the contents data search function different for each of the users. Also, in case of distributing that having the same meta information and the contents data, it is possible to alter or change, not only each of the users, but also to the same user by sending a coding key to the contents producer and/or the distributor. Therefore, it is possible to provide the information in more detailed and/or the search function of superior usability available for a person who paid a high amount of fees, thereby building up one business configuration. As a method for distribution of the contents data and the meta information, it does not matter to distribute through the network or a medium, and it is also same to key distribution.

In the case where the reading is restricted through linking, not only the meta information, but also the contents data relating thereto, it is possible to change that which can be read by each of the users, as was mentioned in the embodiment 2, and is applicable into other embodiments.

Also, in the case where the linking is made between the meta information and the contents data relating thereto, it is possible to make, not only readable or not, but also to change the picture quality, or to change the term during when the reproduction thereof can be made (i.e., being visible on air, visible after one-week later, visible anytime, restricted on the time when it can be seen), or to change the number of times of being visible, etc., therefore there are various configurations of business.

From the above, in particular, when reproducing/recording the recording data, it is possible to make the conditions and/or the regions relating to the meta information through unification of the contents, by providing a means for each of terminals or a user to produce the contents corresponding to the situation; thereby, obtaining the data protection, and also providing an effective usability for the user.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A reproducing apparatus, comprising:
a reproducing means for reproducing contents data, which are recorded onto a recording medium, and meta data relating to Said contents data;
an outputting means for outputting the contents data and the meta data, which are reproduced by said reproducing means, to a display means; and
a controller means for controlling said reproducing means and said output means, wherein
said meta data has meta management information and meta information, said meta information being usable in searching, and
said controller means for conducting control, upon basis of said meta management information, not to reproduce said meta information by means of said reproducing means, nor to output it by said outputting means.

2. The reproducing apparatus, as is described in the claim 1, wherein said meta information is information that describes about meanings or contents of data of said contents.

3. The reproducing apparatus, as is described in the claim 1, wherein said meta information is information relating a person, a picture of whom is taken into said contents.

4. The reproducing apparatus, as is described in the claim 1, wherein said controller means conducts the control, upon basis of said meta management information and a key memorized in said reproducing means, not to reproduce said meta information by means of said reproducing means, nor to output it by said outputting means, irrespective of said contents.

5. The reproducing apparatus, as is described in the claim 1, wherein said meta management information is information that manages the meta information, which can be read by each of users.

6. The reproducing apparatus, as is described in the claim 1, wherein said controller means conducts the control, upon basis of said meta management information, not to reproduce also the contents data relating to said meta information by means of said reproducing means, nor to output it by said outputting means.

7. A reproducing method for reproducing contents data and meta data relating to said contents data, being recorded onto a recording medium, wherein said meta data has meta management information and meta information, said meta information being usable in searching, and said meta information is, upon basis said meta management information, not reproduced, nor outputted to a display means.

8. The reproducing method, as is described in the claim 7, wherein said meta information is information that describes about meanings or contents of data of said contents.

9. The reproducing method, as is described in the claim 7, wherein said meta information is information relating a person, a picture of whom is taken into said contents.

10. The reproducing method, as is described in the claim 7, wherein said meta information is controlled, upon basis of said meta management information and a key memorized in said reproducing means, not to reproduced, nor to outputted, irrespective of said contents.

11. The reproducing method, as is described in the claim 7, wherein said meta management information is information that manages the meta information, which can be read by each of users.

12. The reproducing method, as is described in the claim 7, wherein the contents data relating to said meta information is also controlled, not to reproduced nor to outputted, upon basis of said meta management data.

13. A computer program product stored on a computer readable medium, said computer program product comprising:
code for reproducing contents data, which are recorded onto a recording medium, and meta data relating to said contents data;
code for outputting the contents data and the meta data, which are reproduced by said reproducing means, to a display means; and
code for controlling said reproducing means and said output means, wherein
said meta data has meta management information and meta information, said meta information being usable in searching, and further comprises,
code for conducting control, upon basis of said meta management information, not to reproduce said meta information by means of said reproducing means, nor to output it by said outputting means.
